(19) United States
(12) Patent Application Publication
(10) Pub. No.: US 2012/0030113 A1
(43) Pub. Date: Feb. 2, 2012

(54) Generation And Use Of Negotiable Instruments

(75) Inventors: Timothy James Mark, Berkley, CA (US); Tony England, Tega Cay, SC (US); Kim Leah Bunn, St. Johns, FL (US); Vladimir B. Kasperovich, Atlanta, GA (US)

(73) Assignee: BANK OF AMERICA CORPORATION, Charlotte, NC (US)

(21) Appl. No.: 12/847,637

(22) Filed: Jul. 30, 2010

(51) Int. Cl. G06Q 40/00; G06Q 20/00

(52) U.S. Cl. 705/44; 235/379

(57) ABSTRACT

Systems and methods for generating and using negotiable instrument are described. A request from a user to generate a negotiable instrument financially secured by a financial entity against an account of the user is received, and the user is authenticated to the account of the user with the financial entity. Upon authenticating the user to the account, data representative of the negotiable instrument financially secured by the financial entity against the account of the user is transmitted. The data may include a printable image and barcode for scanning by a second computing device of the financial entity. The transmitted data representative of the negotiable instrument may be received by a computing device. The computing device may output the data representative of the negotiable instrument to a printer for local generation of the negotiable instrument on the printer without the need for special inks and/or other data.

### BACKGROUND

Customer retention is a goal that any entity likely strives to maintain. In addition, providing new and/or useful products and/or services often is another goal of an entity. A recent service provided to some customers of a financial entity is an online banking service. Customers of a financial entity may access a web site of the entity and make payments to people and/or entities for products purchased and/or services rendered. Yet customers do not have an ability to generate a negotiable instrument locally at her own computer at home where the negotiable instrument is financially secured by the financial entity of the customer.

A payor often writes a physical check and/or provides cash to a payee for payment on a service and/or product. In cases in which the payor strives to live in a paper free environment for payment on services and/or products, the payor may still have to provide a check and/or cash to a payee that desires to have a physical payment. Payors do not have the ability to add value to a cash value debit card as a payment for a product and/or service.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the present disclosure are directed to a method and system for generating and using negotiable instrument are described. A request from a user to generate a negotiable instrument financially secured by a financial entity against an account of the user is received, and the user is authenticated to the account of the user with the financial entity. Upon authenticating the user to the account, data representative of the negotiable instrument financially secured by the financial entity against the account of the user is transmitted. The data may include a printable image and barcode for scanning by a second computing device of the financial entity.

Other aspects of the present disclosure are directed to a method and system for using a locally generated negotiable instrument. A request from a user to generate a negotiable instrument financially secured by a financial entity against an account of the user is transmitted. A request for authentication of the user to the account of the user with the financial entity is received. Upon the user being authenticated to the account, data representative of the negotiable instrument financially secured by the financial entity against the account of the user is received. The data representative of the negotiable instrument may include a printable image and barcode for scanning by a second computing device of the financial entity. The data representative of the negotiable instrument is outputted to a printer. A computing device may output the data representative of the negotiable instrument to a printer for local generation of the negotiable instrument on the printer without the need for special inks and/or other data.

Still other aspects of the present disclosure are directed to methods and systems for generation of cash value debit cards. A request from a user to add value to a cash value debit card account financially secured by a financial entity against an account of the user may be received. The user may be authenticated to the account of the user with the financial entity. Monetary funds may be debited from the account of the user by an amount to add to the cash value debit card account, and the debited amount may be added to the cash value debit card account.

Still other aspects of the present disclosure are directed to use of cash value debit cards. A request to withdraw an amount of monetary funds from a cash value debit card account may be received. A determination may be made as to whether to authorize the withdrawal of the amount of monetary funds from the cash value debit card account. The withdrawal of the requested amount may be authorized, and the cash value debit card account may be debited the amount of the request to withdraw monetary funds.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is an illustrative functional block diagram of a self-service financial transaction device (SSFTD) in accordance with at least one aspect of the present disclosure;

FIG. 4 is an illustrative block diagram of a system for locally generating a negotiable instrument in accordance with at least one aspect of the present disclosure;

FIG. 5 is an illustrative flowchart of a method for locally generating a negotiable instrument in accordance with at least one aspect of the present disclosure;

FIG. 6 is another illustrative flowchart of a method for locally generating a negotiable instrument in accordance with at least one aspect of the present disclosure;

FIG. 7 is an illustrative block diagram of a system for utilizing cash value debit cards in accordance with at least one aspect of the present disclosure; and

FIG. 8 is an illustrative flowchart of a method for adding value to a cash value debit card account in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

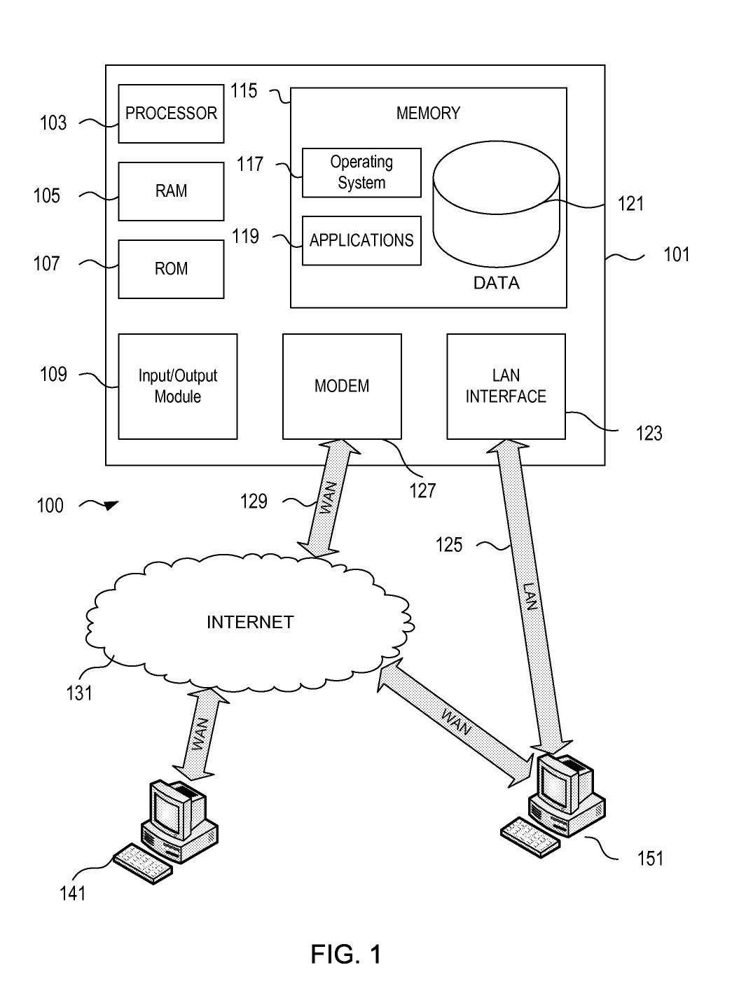

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with individuals, allowing interoperability between different elements of the business residing at different physical locations.

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

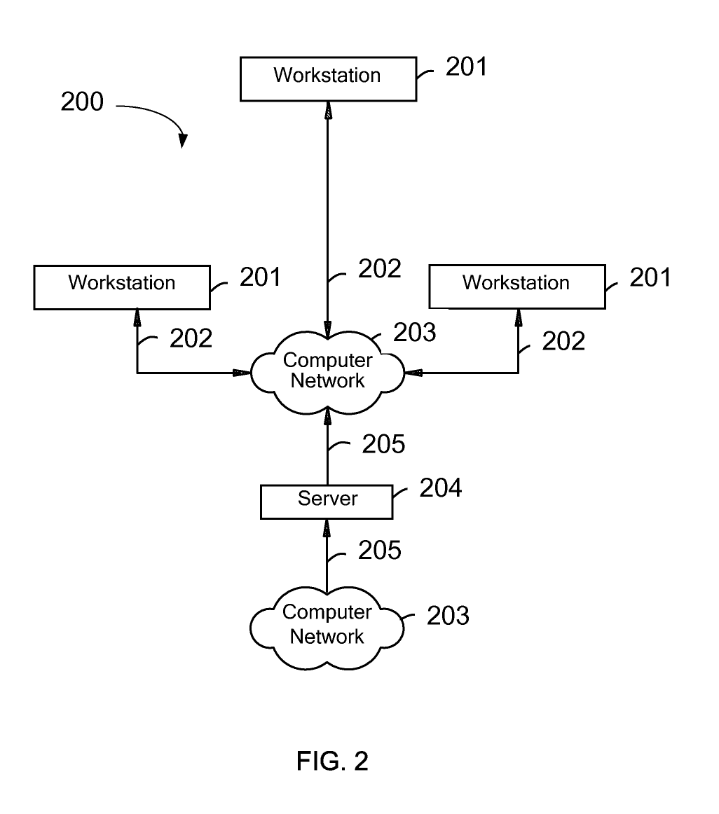

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

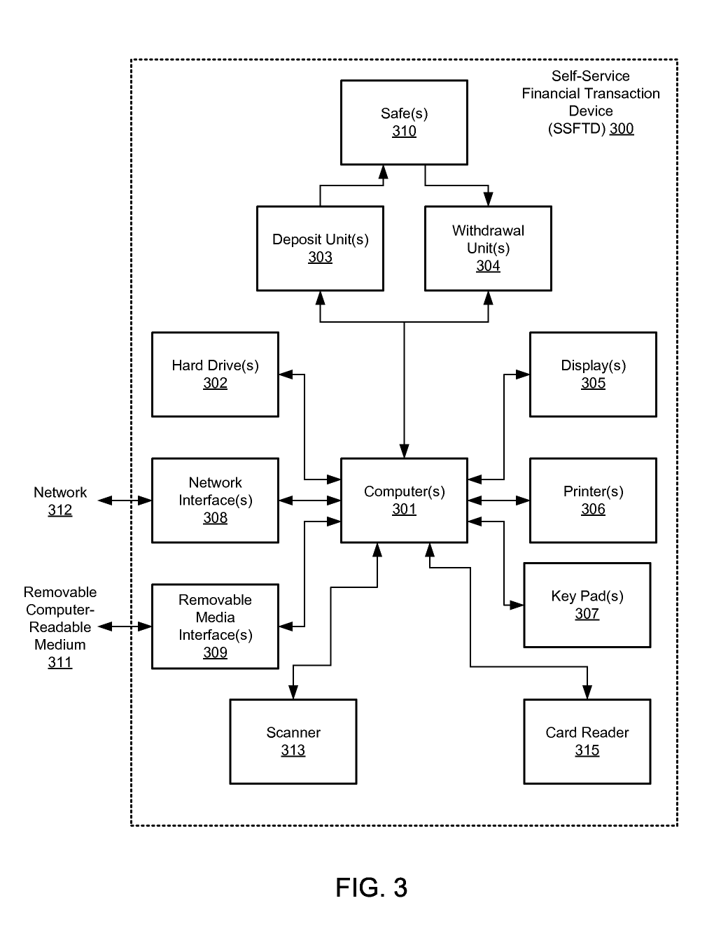

FIG. 3 is an illustrative functional block diagram of a self-service monetary device (SSFTD) 300. SSFTD 300 may include, for instance, an automated teller machine (ATM) or automated kiosk for depositing and/or withdrawing monetary amounts. While the withdrawals are typically provided to the user of the SSFTD 300 as currency, the deposits may be in the form of currency, checks, or other forms.

SSFTD 300 as shown in FIG. 3 includes a computer 301, a hard drive 302 or other computer-readable medium, a deposit unit 303, a withdrawal unit 304, a display 305, a printer 306, a keypad 307, a network interface 308, a removable media interface 309, a safe 310, a scanner 313, a card reader 315, and a camera 317. Although computer 301 is labeled as a “computer,” any one or more of the other functional blocks in FIG. 3 may also be or include a computer. As understood, SSFTD 300 may include one or more computers 301, hard drives 302, deposit units 303, withdrawal units 304, displays 305, printers 306, key pads 307, network interfaces 308, removable media interfaces 309, safes 310, scanners 313, and car readers 315.

The term “computer” as referred to herein broadly refers to any electronic, electro-optical, and/or mechanical device, or system of multiple physically separate or physically joined such devices, that is able to process and manipulate information, such as in the form of data. Non-limiting examples of a computer include one or more personal computers (e.g., desktop or laptop), servers, smart phones, personal digital assistants (PDAs), television set top boxes, and/or a system of these in any combination or subcombination. In addition, a given computer may be physically located completely in one location or may be distributed amongst a plurality of locations (i.e., may implement distributive computing). A computer may be or include a general-purpose computer and/or a dedicated computer configured to perform only certain limited functions.

A computer typically includes hardware that may execute software and/or be configured in hardware to perform specific functions. The software may be stored on a computer-readable medium in the form of computer-readable instructions. A computer may read those computer-readable instructions, and in response perform various steps as defined by those computer-readable instructions. Thus, any functions attributed to any of the functional blocks of FIG. 3 as described herein may be implemented, for example, by reading and executing such computer-readable instructions for performing those functions, and/or by any hardware subsystem (e.g., a processor) from which the computer is composed.

The term “computer-readable medium” as used herein includes not only a single physical medium or single type of medium, but also a combination of one or more physical media and/or types of media. Examples of a computer-readable medium include, but are not limited to, one or more memory chips, hard drives (e.g., hard drive 302), optical discs (such as CDs or DVDs), magnetic discs, and magnetic tape drives. A computer-readable medium may be considered part of a larger device or it may be itself removable from the device. For example, a commonly-used removable computer-readable medium is a universal serial bus (USB) memory stick that interfaces with a USB port of a device.

A computer-readable medium may store computer-readable instructions (e.g., software) and/or computer-readable data (i.e., information that may or may not be executable). In the present example, a computer-readable medium (such as memory) may be included in any one or more of the functional blocks shown in FIG. 3 and may store computer-executable instructions and/or data used by any of those functional blocks. Alternatively or additionally, such a computer-readable medium storing the data and/or software may be physically separate from, yet accessible by, any of the functional blocks shown in FIG. 3.

Where SSFTD 300 is an ATM, computer 301 is typically embodied as a personal computer. In this example, computer 301 may be responsible for the overall control of SSFTD 100. To perform such control, computer 301 may execute, for example, one or more software applications, one or more device control programs, and one or more operating systems, each of which may be stored on hard drive 302, which may be a single physical hard drive or multiple physical hard drives. These various elements will be discussed in further detail below.

Hard drive 302 may be a single physical hard drive unit or may include multiple physical hard drive units. Rather than, or in addition to, hard drive 302, SSFTD 300 may store data and/or computer-executable instructions on one or more other types of computer-readable medium, such as an optical disc drive, a magnetic tape drive, and/or memory chips.

Deposit unit 303 may be responsible for physically receiving deposited items such as currency and checks, for physically counting the deposited items, for physically holding the deposited items in an escrow area during a deposit transaction, for determining the value of the deposited items, and for physically transferring the deposited items to safe 310 when the transaction is complete.

Withdrawal unit 304 may be responsible for physically retrieving currency or other items from safe 310 during a withdrawal transaction, and for physically providing the retrieved currency to the user.

Display 305 may be responsible for displaying a visual user interface to the user, and may also incorporate a touch screen capability for receiving user input. Typical information that may be presented on display 305 includes text and/or graphics representing the status of a transaction. Likewise, printer 306 may be responsible for presenting a paper printout containing information about a transaction.

Key pad 307 may include one or more buttons, switches, and/or other physical user input elements, and may be responsible for receiving user input associated with a transaction. For example, key pad 307 may include digit keys zero through nine and other function keys. Card reader 315 may be any type of device that reads data from a card, such as the magnetic strip on magnetic cards such as ATM/bank cards.

Network interface 308 may be responsible for data communication between SSFTD 300 and a network 312. The communication may be uni-directional or bi-directional. Network 312 may be a single network or combination of multiple coupled networks, and may be wireless and/or wired. Examples of network 312, or portions thereof, include the Internet, a cellular telephone network, a cellular data network, a wired or wireless local area network, and a satellite communication network.

Removable media interface 309 may be responsible for reading from and/or writing to a removable computer-readable medium 311, such as a USB key, a compact disc (CD), a floppy magnetic disc, or a portable hard drive. Removable media interface 309 may therefore include a physical port for plugging in or otherwise temporarily receiving removable computer-readable medium 311. This port may be physically part of, for instance, the housing of computer 301. However, the port may be located elsewhere in or on SSFTD 300, such as on a rear housing of SSFTD 300 that may be accessible to maintenance servicers of SSFTD 300 but not necessarily to the general public. Regardless of the location of the port, data read from removable computer-readable medium 311 by removable media interface 309 may be provided to computer 301, and data provided by computer 301 may be written by removable media interface 309 to computer-readable medium 311.

Scanner 313 may include, for instance, a camera that is able to take a digital photograph of a negotiable instrument to produce one or more images representing the front and/or back of the negotiable instrument. In addition to generating an image of the negotiable instrument, scanner 313 may be further capable of reading a barcode printed on the negotiable instrument.

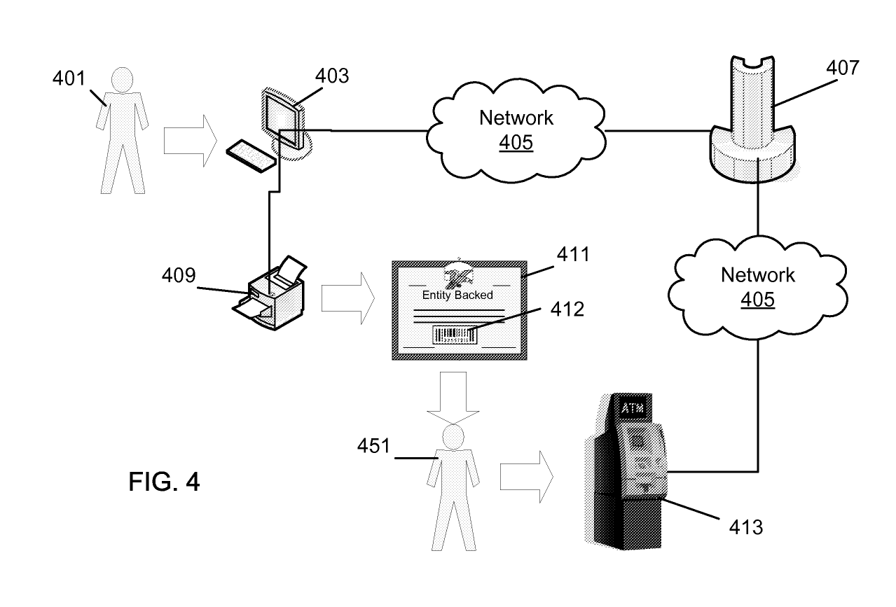

FIG. 4 is an illustrative block diagram of a system for local generation of a negotiable instrument in accordance with at least one aspect of the present disclosure. The system shows a user 401 accessing a computer 403. Computer 403 may be a computer 101, 141, and/or 151 as described in FIG. 1 and/or a workstation 201 as described in FIG. 2. Computer 403 may be operatively connected to network 405 by any of a number of different manners including a wireless connection, a wired connection, or a combination of wired and wireless connections. In addition, computer 403 may be any type of computing device, such as a desktop computer, a wireless lap top computer, a cellular telephone with compatibility to communicate with network 405, and/or other types of computing devices. Computer 403 is shown operatively connected to network 405. Network 405 may include one or more wired networks, wireless networks, and/or combinations of wired and wireless networks. Network 405 may be network 312 as described in FIG. 3, Internet 101 as described in FIG. 1, and/or computer network 203 as described in FIG. 2.

An entity 407 may be operatively connected to network 405. As described herein, entity 407 may transmit data representative of a negotiable instrument financially secured by the entity against an account of the user 401 to computer 403. The data representative of the negotiable instrument may include a printable image and a barcode for scanning by a computing device of the entity 407. Such a computing device for scanning of the barcode may be a self service financial transaction device, such as self service financial transaction device 413. Entity 407 may operate self service financial transaction device 413. Entity 407 may be a financial entity offering financial services and products through a self service financial transaction device 413 to users, such as user 451.

The system also shows an output device 409, such as a printer. Output device 409 may be a printer connected to computer 403 at the home of a user 401. Output device 409 may be configured to receive instructions for printing a negotiable instrument 411. Negotiable instrument 411 may be financially secured by the entity 407 against an account of the user 401. Negotiable instrument 411 may include a barcode 412 for scanning by a computing device of the entity 407. As indicated above, such a computing device for scanning of barcode 412 may be a self service financial transaction device, such as self service financial transaction device 413. Negotiable instrument 411 may be paper cash where the recipient user 451 is not specifically identified with the negotiable instrument 411. In another example, negotiable instrument 411 may be a check made out to a particular payee, such as user 451. Negotiable instrument 411 may include a name of the payee, such as user 451, printed on the negotiable instrument 411.

The system shows user 451 accessing self service financial transaction device 413, such as an automated teller machine (ATM). Self service financial transaction device 413 may be a self service financial transaction device 300 as described in FIG. 3. Self service financial transaction device 413 is shown operatively connected through network 405 to entity 407. Self service financial transaction device 413 may be configured to scan barcode 412 of the negotiable instrument 411. The scanned data may be sent to entity 407 for identifying the negotiable instrument 411 associated with the barcode 412. Self service financial transaction device 413 may receive a request to withdraw monetary funds in the amount applied to the negotiable instrument 411 and to output monetary funds in the amount applied to the negotiable instrument 411.

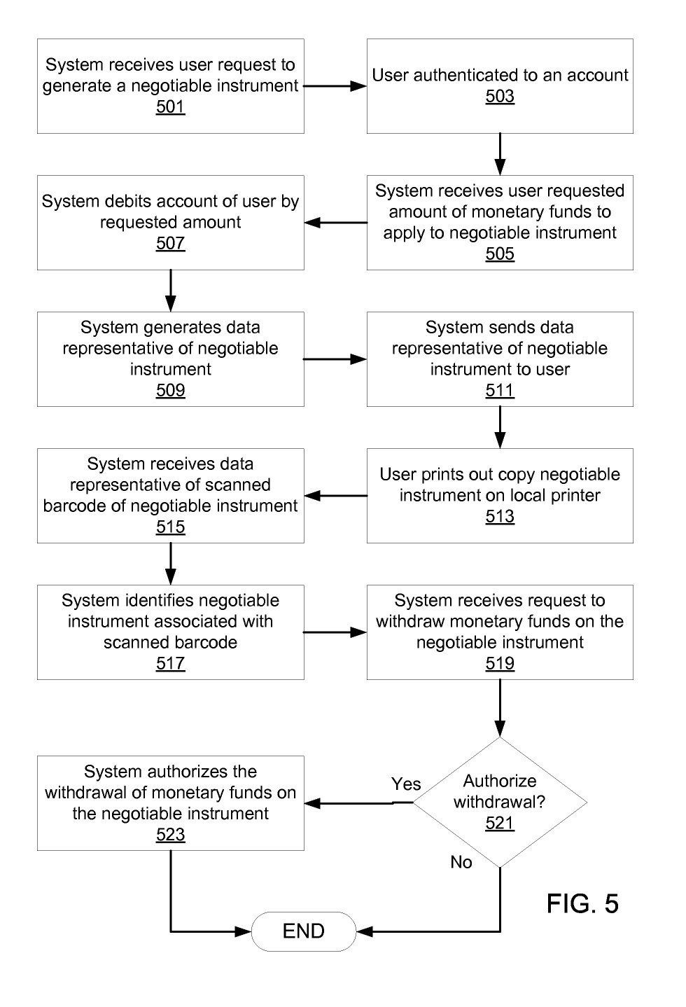

FIG. 5 is an illustrative flowchart of a method for locally generating a negotiable instrument in accordance with at least one aspect of the present disclosure. The process starts and at 501, a system may receive a user request to generate a negotiable instrument financially secured by a financial entity against an account of the user. Such a request may be received from a computer, such as computer 403 by user 401 in FIG. 4. A user may access a web site affiliated with the entity for generation of negotiable instruments financially secured by the entity. Accessing such a web site may be the request in 501.

Proceeding to 503, the user may be authenticated to the account of the user with the entity. Any of a number of manners may be utilized to authenticate the user and the present disclosure is not limited to any particular authentication. An example manner for authentication includes requesting and receiving a user login identification and corresponding personal identification number (PIN) associated with the account. Still other example manners for authentication include scanning a biometric parameter of the user, such as an iris and/or a fingerprint. These and other example manners for authentication of a user may be utilized in accordance with the present disclosure.

Proceeding to 505, the system receives a request from the user of an amount of monetary funds to apply to the negotiable instrument. Such a request may be received from a user entering such data in one or more fields of a web site of the entity. For example, a user may desire to generate a negotiable instrument of a specific amount, such as $22. Any of a number of manners may exist for receiving such a requested amount. In one example, a user may enter the amount by means of a keyboard associated with computer 403 as described in FIG. 4. In 507, the system debits the account of the user associated with the negotiable instrument by the amount requested by the user. In the previous example of $22 being requested by a user, the system may debit $22 from the account of the user that the user has with the entity. As such, the negotiable instrument is secured by the $22 debited from the account of the user.

In 509, the system may generate data representative of the negotiable instrument financially secured by the entity against the transferred monetary funds from the account of the user. In 511, the system may transmit the data representative of the negotiable instrument financially secured by the entity against the account of the user. The system may transfer the data to a computing device, such as computer 403 in FIG. 4. The data may include a printable image and barcode for scanning by a computing device of the entity. Such a computing device of the entity, as described below, may be a self service financial transaction device, such as self service financial transaction device 413 in FIG. 4.

Proceeding to 513, a user may print out a copy of the negotiable instrument on a local printer. Such a user may be user 401 in FIG. 4, and the user may utilize a personal computer attached to a printer, such as computer 403 attached to output device 409 in FIG. 4. The copy of the negotiable instrument printed in 513 may be negotiable instrument 411 with barcode 412 described in FIG. 4.

In 515, the system receives data representative of the scanned barcode of the negotiable instrument. Such data may be received from a self service financial transaction device scanning the barcode on the negotiable instrument, such as self service financial transaction device 413 scanning barcode 412 on negotiable instrument 411 in FIG. 4. Moving to 517, the system may identify the negotiable instrument corresponding to the scanned barcode data. For example, the system may include a database with a cross reference table of negotiable instrument identification to scanned barcode data.

In 519, the system may receive a request for withdrawal of monetary funds on the negotiable instrument. Such a request may be a user input received via key pad 307 as described in FIG. 3 for withdrawal of cash against the negotiable instrument. The request may be user 451 accessing the self service financial transaction device 413 in FIG. 4. In 521 a determination may be made as to whether the withdrawal of monetary funds against the negotiable instrument is authorized. Such a determination may be based upon the system determining the amount of monetary funds applied to the negotiable instrument. For example, the negotiable instrument may be a check made out to a particular payee in the amount of $22. If the user attempting to withdraw monetary funds against the negotiable instrument is not the particular payee associated with the negotiable instrument, the system may prevent withdrawal. Prior to the process ending, the system may generate a message to the user indicating that the request to withdraw monetary funds against the negotiable instrument could not be granted. In another example, the negotiable instrument may act as paper cash and, as such, the negotiable instrument is not associated with the particular payee.

If withdrawal of the monetary funds is authorized in 521, the process moves to 523 where the system authorizes the withdrawal of the monetary funds on the negotiable instrument. For the example system shown in FIG. 4, self service financial transaction device 413 may output monetary funds in the amount of the negotiable instrument 411 to user 451.

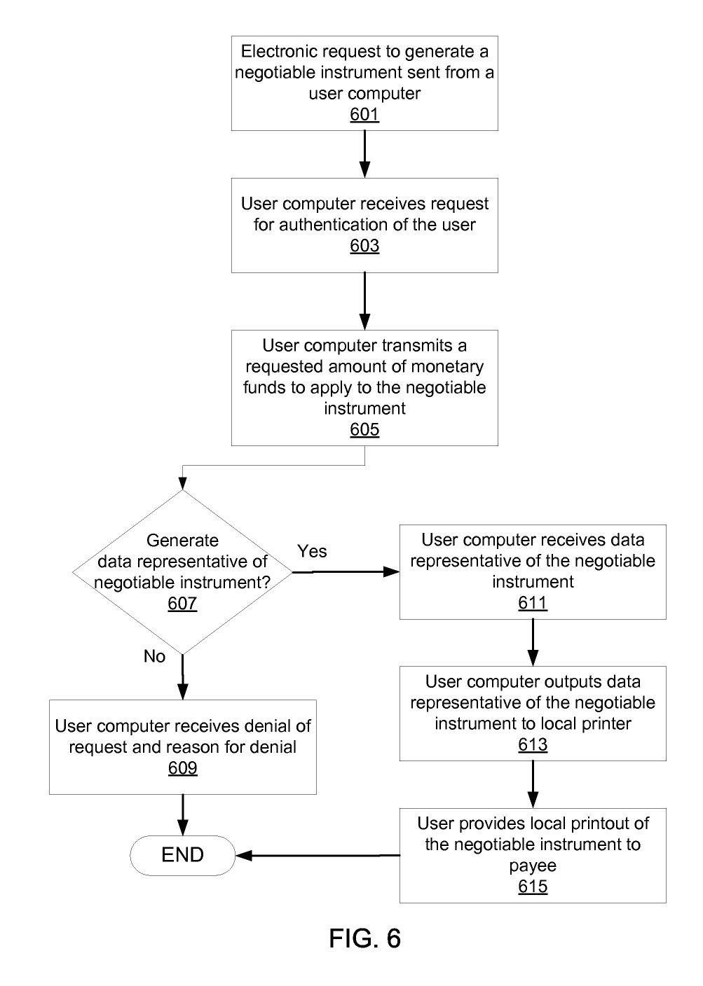

FIG. 6 is another illustrative flowchart of a method for locally generating a negotiable instrument in accordance with at least one aspect of the present disclosure. The process starts and at 601, an electronic request to generate a negotiable instrument financially secured by a financial entity against an account of a user may be sent from a user computer. Such a request may be sent from a computer, such as computer 403 by user 401 in FIG. 4. A user may access a web site affiliated with the entity for generation of negotiable instruments financially secured by the entity. Accessing such a web site may be the request in 601.

Proceeding to 603, the user computer may receive a request for authenticated of the user to the account of the user with the entity. Any of a number of manners may be utilized to authenticate the user and the present disclosure is not limited to any particular authentication. An example manner for authentication includes requesting and receiving a user login identification and corresponding personal identification number (PIN) associated with the account. Still other example manners for authentication include scanning a biometric parameter of the user, such as an iris and/or a fingerprint. These and other example manners for authentication of a user may be utilized in accordance with the present disclosure.

Proceeding to 605, the user computer may transmit a request of an amount of monetary funds to apply to the negotiable instrument. Such a request may be sent from a user computer when a user enters such data in one or more fields of a web site of the entity. In 607, a determination may be made as to whether to generate data representative of the negotiable instrument requested by the user. The system may confirm that monetary funds are available in the account of the user to secure against the negotiable instrument. If not, the data representative of the negotiable instrument may not be generated. If it is determined not to generate data representative of the negotiable instrument in 607, the process moves to 609 where the user computer may receive a message indicating a denial of the request and a reason for the denial of the request. If it is determined to generate data representative of the negotiable instrument in 607, the process moves to 611.

In 611, the user computer may receive the data representative of the negotiable instrument. The data representative of the negotiable instrument may include a printable image and barcode for scanning by a computing device of the entity, such as self service financial transaction device 413 in FIG. 3. Proceeding to 613, the user computer may output the data representative of the negotiable instrument to an output device, such as a local printer, of the user computer. Such an example may include output device 409 operatively connected to computer 403 in FIG. 4. In 415, the user may utilize the printout of the negotiable instrument by providing it to a payee. Such a situation may be a payment for services by a babysitter or lawn care worker. With the printout of the negotiable instrument, the payee may access a self service financial transaction device and/or a branch office of a financial entity, such as the entity that secured the negotiable instrument, to withdrawal monetary funds against the negotiable instrument.

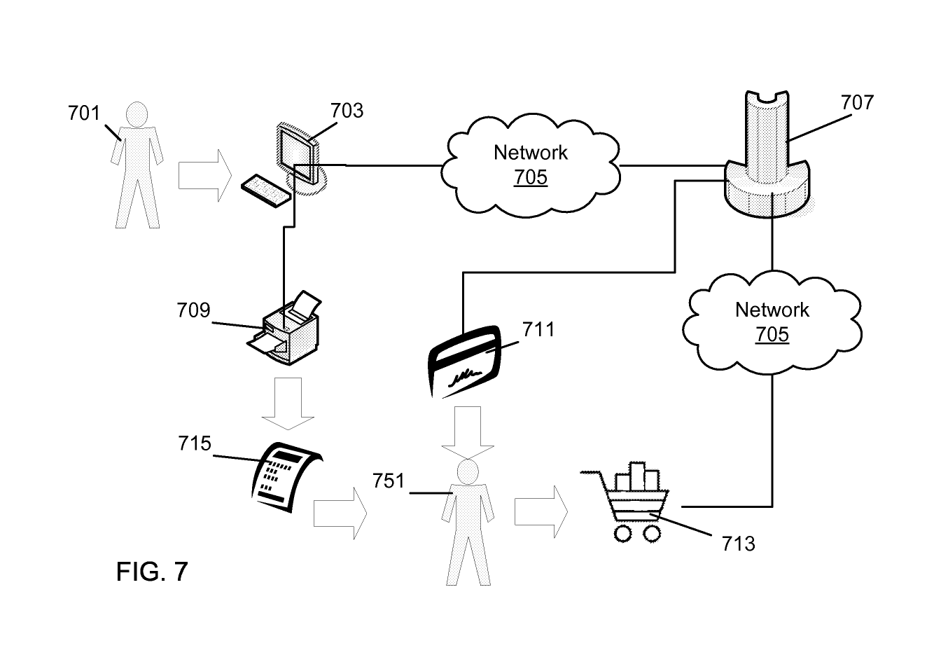

FIG. 7 is an illustrative block diagram of a system for utilizing cash value debit cards in accordance with at least one aspect of the present disclosure. The system shows a user 701 accessing a computer 703. Computer 703 may be a computer 101, 141, and/or 151 as described in FIG. 1 and/or a workstation 201 as described in FIG. 2. Computer 703 may be operatively connected to network 705 by any of a number of different manners including a wireless connection, a wired connection, or a combination of wired and wireless connections. In addition, computer 703 may be any type of computing device, such as a desktop computer, a wireless lap top computer, a cellular telephone with compatibility to communicate with network 705, and/or other types of computing devices. Computer 703 is shown operatively connected to network 705. Network 705 may include one or more wired networks, wireless networks, and/or combinations of wired and wireless networks. Network 705 may be network 312 as described in FIG. 3, Internet 101 as described in FIG. 1, and/or computer network 203 as described in FIG. 2.

An entity 707 may be operatively connected to network 705. As described herein, entity 707 may add value to a cash debit card account financially secured by the entity 707 against an account of the user 701. Entity 707 may be a financial entity offering financial services and products to users, such as user 701.

The system also shows an output device 709, such as a printer. Output device 709 may be a printer connected to computer 703 at the home of a user 701. Output device 709 may be configured to receive instructions for printing a receipt 715 to confirm that monetary funds have been transferred to a cash value debit card account. A cash value debit card account associated with a cash value debit card 711 may be financially secured by the entity 707 against an account of the user 701. Cash value debit card 711 may include a magnetic strip for scanning by a computing device 713. Cash value debit card 711 may be an anonymous card where a recipient user 751 is not specifically identified with the cash value debit card 711. In another example, cash value debit card 711 may be associated with a particular payee, such as user 751. Cash value debit card 711 may include a name of the payee, such as user 751, magnetically stored on the cash value debit card 711.

The system shows user 751 using cash value debit card 711 at a purchase point 713. Such a purchase point may be a store, such as a grocery store, a department store, a car dealership, and/or any type of store that may allow users to make payments via a debit card. As such, on line merchants may be purchase points as well. Purchase point 713 is shown operatively connected through network 705 to entity 707. Entity 707 may receive requests to add value to the cash value debit card account associated with cash value debit card 711 and/or requests to charge against a current value stored in the cash value debit card account of cash value debit card 711.

The system of FIG. 7 may be utilized where a user 701 desires to make a payment to a payee 751. For example, a parent may be a user 701 desiring to make a payment to a babysitter, payee 751, for services rendered in babysitting a child. User 701 may access a web site of entity 707 for adding value to a cash value debit card of the payee 751. The user 701 may electronically transfer, through computer 703, monetary funds in a specific amount, such as $50 for the babysitting service, to the cash value debit card account of the payee 751. User 701 may make such a transfer by knowing a cash value debit card account identifier of the payee 751, such as a number of the payee 751 and/or a number for the cash value debit card. Entity 707 make debit the amount form the account of user 701 affiliated with the entity 707 and add the debited value to the cash value debit card account of the payee 751. Concurrently, user 701 may provide a confirmation receipt 715 of the transfer of monetary funds to the cash value debit card account of the payee 751. In one example, the cash value debit card account associated with a cash value debit card 711 may not be associated with a particular payee 751. User 701 may request generation of a cash value debit card 711 in a specific amount and have the cash value debit card 711 sent to user 701. User 701 then may give the cash value debit card 711 to a user 751 and the user 751 would remain anonymous to the entity 707.

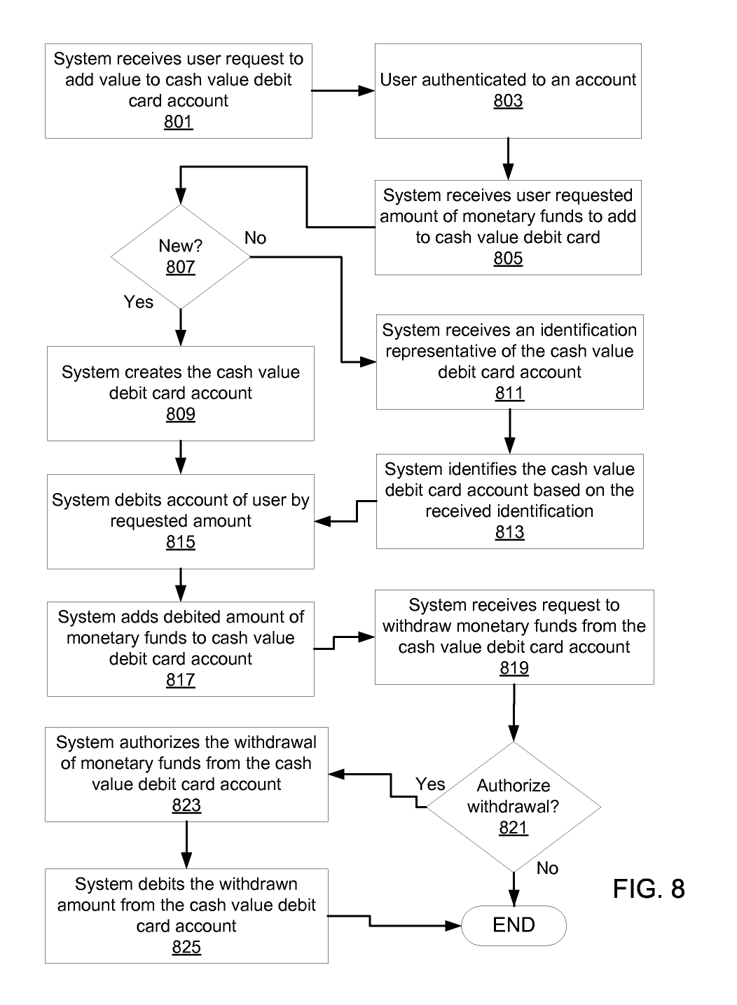

FIG. 8 is an illustrative flowchart of a method for adding value to a cash value debit card account in accordance with at least one aspect of the present disclosure. The process starts and at 801, a system may receive a request from a user to add value to a cash value debit card account. Such a request may be by user 701 through computer 703 to entity 707 in FIG. 7. A user may access a web site affiliated with the entity 707 for adding value to a cash value debit card financially secured by the entity. Accessing such a web site may be the request in 801. Proceeding to 803, the user may be authenticated to the account of the user with the entity. Any of a number of manners may be utilized to authenticate the user and the present disclosure is not limited to any particular authentication.

Proceeding to 805, the system receives a request from the user of an amount of monetary funds to add to the cash value debit card account. Such a request may be received from a user entering such data in one or more fields of a web site of the entity. For example, a user may desire to add a monetary value of a specific amount, such as $105. Any of a number of manners may exist for receiving such a requested amount. In one example, a user may enter the amount by means of a keyboard associated with computer 703 as described in FIG. 7. In 807, a determination may be made as to whether the cash value debit card account being requested is a new cash value debit card account. For example, a user may want to add value to a previously existing cash value debit card account. Alternatively, the user may want to add value to a new cash value debit card account.

If the cash value debit card account for adding value to is new in 807, the process moves to 809 where the system creates the cash value debit card account as a new cash value debit card account. If the cash value debit card account is to be associated with a particular payee, the system may request and receive data of the particular payee, such as a name, address, etc. The process then moves to 815.

If the cash value debit card account for adding value to is not new in 807, the process moves to 811 where the system may receive an identification representative of the cash value debit card account. Such identification may be a name of the payee, an account number associated with the cash value debit card account, and/or other data. A user may receive such data from a payee and then enter such data in one or more fields of a web site of an entity offering such a cash value debit card adding service. Proceeding to 813, the system identifies the cash value debit card account based upon the received identification data.

In 815, the system debits the account of the user requesting the adding of value to the cash value debit card by the requested amount in 805. In 817, the system adds the debited amount of monetary funds to the cash value debit card account. In the example above of desiring to add a specific amount of $105 in 805, the cash value debit card account following 817 includes an additional $105. The same amount of $105 was debited from the account of the user in 815. The transfer of the physical card would be between 817 and 819.

Although not shown in FIG. 8, the cash value debit card may be provided to a payor in a number of manners between 817 and 819. If the cash value debit card is a new cash value debit card, as in from 807 to 809 and then to 815, the system may have the physical cash value debit card sent, e.g., via the mail, to a payee when the user in 801 and account holder in 803 is a payor. In another example where the cash value debit card is a new cash value debit card, the system may have the physical cash value debit card sent, e.g., in the mail, to the payor, e.g., the user and account owner in 801 and 803. In such a case, the payor may physically transfer the cash value debit card to a payee. In still another example where the cash value debit card is a new cash value debit card, the system may have the physical cash value debit card available for pick up by a payee when the user in 801 and account holder in 803 is a payor. In such an example, a recipient of the cash value debit card, e.g., a payee for services rendered to a payor, e.g., the user in 801, may enter a local branch office of the entity associated with the cash value debit card. For example, if the entity is a financial entity, a payee may go to any branch office of the entity and obtain the cash value debit card created in 809. In such an example, authentication of the payee as the correct recipient of the cash value debit card may be required for physical transfer of the cash value debit card to the payee. In yet another example where the cash value debit card is not new, as in from 807 to 811, 813, and then 815, the cash value debit card already may be in physical possession of the payee. As such, a physical transfer to the payee is not needed.

Moving to 819, the system may receive a request for withdrawal of monetary funds from the cash value debit card account. Such a request may be a user providing the cash value debit card to an operator at a purchase point and having the operator transmit a request to charge for a product or service against the cash value debit card. The request may be user 751 accessing the purchase point 713 in FIG. 7. In 721 a determination may be made as to whether the withdrawal of monetary funds from the cash value debit card account is authorized. Such a determination may be based on determining a total amount of monetary funds in the cash value debit card account and comparing the total amount of monetary funds to the requested amount of monetary funds to withdraw. The cash value debit card may be made out to a particular payee in the amount of $57. If the user attempting to withdraw monetary funds from the cash value debit card account is not a particular payee associated with the cash value debit card account, the system may prevent withdrawal. Prior to the process ending, the system may generate a message to the user indicating that the request to withdraw monetary funds from the cash value debit card could not be granted. In another example, the cash value debit card may not have a particular payee associated with the card and, as such, any individual may use the cash value debit card for purchases to withdraw monetary funds from the cash value debit card account.

If withdrawal of the monetary funds is authorized in 821, the process moves to 823 where the system authorizes the withdrawal of the monetary funds from the cash value debit card account. Proceeding to 825, the system debits the withdrawn amount from the cash value debit card account. Included in 825 may be other data to a merchant associated with the charge on the cash value debit card for documentation of the transaction.

While illustrative systems and methods as described herein embodying various aspects of the present disclosure are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present disclosure. The description is thus to be regarded as illustrative instead of restrictive on the present invention.

What is claimed is:

1. A method comprising:
receiving, at a first computing device, a request from a user to generate a negotiable instrument financially secured by a financial entity against an account of the user;
authenticating, by the first computing device, the user to the account of the user with the financial entity; and
upon authenticating the user to the account, transmitting, from the first computing device, data representative of the negotiable instrument financially secured by the financial entity against the account of the user, the data including a printable image and barcode for scanning by a second computing device of the financial entity.

2. The method of claim 1, further comprising receiving, at the first computing device, a requested amount of monetary funds to apply to the negotiable instrument.

3. The method of claim 2, further comprising transferring, by the first computing device, monetary funds from the account of the user in the requested amount of monetary funds.

4. The method of claim 3, further comprising generating, by the first computing device, data representative of the negotiable instrument financially secured by the financial entity against the transferred monetary funds from the account of the user.

5. The method of claim 1, further comprising:
receiving, at the first computing device, data representative of the barcode of the negotiable instrument from the computing device of the financial entity;
identifying, by the first computing device, the negotiable instrument associated with the barcode;
receiving, at the first computing device, a request to withdraw monetary funds in the amount applied to the negotiable instrument;
determining, by the first computing device, whether to authorize a withdrawal of monetary funds in the amount applied to the negotiable instrument; and
authorizing, by the first computing device, the withdrawal of monetary funds in the amount applied to the negotiable instrument.

6. The method of claim 5, wherein the determining, by the first computing device, whether to authorize includes determining the amount of monetary funds applied to the negotiable instrument.

7. The method of claim 1, wherein the negotiable instrument is a check made out to a particular payee.

8. A method comprising:
transmitting, from a first computing device, a request from a user to generate a negotiable instrument financially secured by a financial entity against an account of the user;
receiving, at the first computing device, a request for authentication of the user to the account of the user with the financial entity;
upon the user being authenticated to the account, receiving, at the first computing device, data representative of the negotiable instrument financially secured by the financial entity against the account of the user, the data representative of the negotiable instrument including a printable image and barcode for scanning by a second computing device of the financial entity; and
outputting, by the first computing device, the data representative of the negotiable instrument to a printer.

9. The method of claim 8, wherein the negotiable instrument is a check made out to a particular payee.

10. The method of claim 8, further comprising transmitting, by the first computing device, a requested amount of monetary funds to apply to the negotiable instrument, wherein the data representative of the negotiable instrument includes the requested amount of monetary funds.

11. One or more computer-readable media storing computer-readable instructions that, when executed by at least one computer, cause the at least one computer to perform a method of:
receiving a request from a user to generate a negotiable instrument financially secured by a financial entity against an account of the user;
authenticating the user to the account of the user with the financial entity; and
upon authenticating the user to the account, transmitting data representative of the negotiable instrument financially secured by the financial entity against the account of the user, the data including a printable image and barcode for scanning by a second computing device of the financial entity.

12. The one or more computer-readable media of claim 11, the instructions further causing the at least one computer to perform a method of:
receiving a requested amount of monetary funds to apply to the negotiable instrument;
transferring monetary funds from the account of the user in the requested amount of monetary funds; and
generating data representative of the negotiable instrument financially secured by the financial entity against the transferred monetary funds from the account of the user.

13. The one or more computer-readable media of claim 11, the instructions further causing the at least one computer to perform a method of:
receiving, at the first computing device, data representative of the barcode of the negotiable instrument from the computing device of the financial entity;
identifying, by the first computing device, the negotiable instrument associated with the barcode;
receiving, at the first computing device, a request to withdraw monetary funds in the amount applied to the negotiable instrument;
determining, by the first computing device, whether to authorize a withdrawal of monetary funds in the amount applied to the negotiable instrument; and
authorizing, by the first computing device, the withdrawal of monetary funds in the amount applied to the negotiable instrument.

14. The one or more computer-readable media of claim 13, wherein the determining whether to authorize includes determining the amount of monetary funds applied to the negotiable instrument.

15. One or more computer-readable media storing computer-readable instructions that, when executed by at least one computer, cause the at least one computer to perform a method of:
transmitting a request from a user to generate a negotiable instrument financially secured by a financial entity against an account of the user;
receiving a request for authentication of the user to the account of the user with the financial entity;
upon the user being authenticated to the account, receiving data representative of the negotiable instrument financially secured by the financial entity against the account of the user, the data representative of the negotiable instrument including a printable image and barcode for scanning by a second computing device of the financial entity; and
outputting the data representative of the negotiable instrument to a printer.

16. The one or more computer-readable media of claim 15, the instructions further causing the at least one computer to perform a method of transmitting a requested amount of monetary funds to apply to the negotiable instrument, wherein the data representative of the negotiable instrument includes the requested amount of monetary funds.

17. The one or more computer-readable media of claim 15, wherein the negotiable instrument is a check made out to a particular payee.

18. An apparatus comprising:
at least one processor; and
at least one memory having stored therein computer executable instructions, that when executed by the at least one processor, cause the apparatus to perform a method of:
receiving a request from a user to generate a negotiable instrument financially secured by a financial entity against an account of the user;
authenticating the user to the account of the user with the financial entity; and
upon authenticating the user to the account, transmitting data representative of the negotiable instrument financially secured by the financial entity against the account of the user, the data including a printable image and barcode for scanning by a second computing device of the financial entity.

19. The apparatus of claim 18, the instructions further causing the apparatus to perform a method of:
receiving a requested amount of monetary funds to apply to the negotiable instrument;
transferring monetary funds from the account of the user in the requested amount of monetary funds; and
generating data representative of the negotiable instrument financially secured by the financial entity against the transferred monetary funds from the account of the user.

20. The apparatus of claim 18, the instructions further causing the apparatus to perform a method of:
receiving, at the first computing device, data representative of the barcode of the negotiable instrument from the computing device of the financial entity;
identifying, by the first computing device, the negotiable instrument associated with the barcode;
receiving, at the first computing device, a request to withdraw monetary funds in the amount applied to the negotiable instrument;
determining, by the first computing device, whether to authorize a withdrawal of monetary funds in the amount applied to the negotiable instrument; and
authorizing, by the first computing device, the withdrawal of monetary funds in the amount applied to the negotiable instrument.

21. The apparatus of claim 20, wherein the determining whether to authorize includes determining the amount of monetary funds applied to the negotiable instrument.

22. An apparatus comprising:
at least one processor; and
at least one memory having stored therein computer executable instructions, that when executed by the at least one processor, cause the apparatus to perform a method of:
transmitting a request from a user to generate a negotiable instrument financially secured by a financial entity against an account of the user;
receiving a request for authentication of the user to the account of the user with the financial entity;
upon the user being authenticated to the account, receiving data representative of the negotiable instrument financially secured by the financial entity against the account of the user, the data representative of the negotiable instrument including a printable image and barcode for scanning by a second computing device of the financial entity; and
outputting the data representative of the negotiable instrument to a printer.

23. The apparatus of claim 22, the instructions further causing the apparatus to perform a method of transmitting a requested amount of monetary funds to apply to the negotiable instrument, wherein the data representative of the negotiable instrument includes the requested amount of monetary funds.

24. The apparatus of claim 22, wherein the negotiable instrument is a check made out to a particular payee.
